(19) United States
(12) Patent Application Publication
(10) Pub. No.: US 2009/0257582 A1
(43) Pub. Date: Oct. 15, 2009

(54) Block-based stream encryption/decryption processing method

(76) Inventor: Chiou-Haun Lee, Taichung City (TW)

Correspondence Address: CHARLES E. BAXLEY, ESQUIRE, 90 JOHN STREET, SUITE 309, NEW YORK, NY, 10038, US

(21) Appl. No.: 12/082,928

(22) Filed: Apr. 14, 2008

(51) Int. Cl. H04L 9/06

(52) U.S. Cl. 380/29

(57) ABSTRACT

A block-based stream encryption/decryption processing method for applying a matrix architecture of diffusion algebra includes the steps of (a) selecting a private key and a pairing private key; (b) selecting a plaintext and multiplying the plaintext with the private key to produce a ciphertext; (c) multiplying the ciphertext with the pairing private key to obtain the plaintext; and (d) repeating the steps (b) and (c) to produce encrypted or decrypted block streams.

### BACKGROUND OF THE INVENTION

1. Field of the Invention

The present invention relates to a real-time encryption/decryption method for stream images, and more particularly to a method of encrypting/decrypting a block matrix by diffusion algebra.

2. Description of the Related Art

In a traditional stream encryption/decryption method, the operation of nonlinear combined functions and the feedback of shift registers are used to obtain a plurality of bits continuously and sequentially from the registers and perform an XOR operation with a plaintext stream to produce a ciphertext stream. As to decryptions, a similar XOR operation is performed with the ciphertext stream to sequentially obtain the plaintext stream.

One of the requirements for a real time encryption/decryption is to minimize the wait time of an encryption/decryption process, and the prior art uses a bit as a unit for the simple and quick operations of the one-bit encryption and the real time one-bit decryption.

The output value of the prior art depends on the nonlinear functions and encryption streams, and thus images have to be played from the beginning and cannot be accessed randomly. Based on the consideration of safety, one bit can be processed at a time, if a bit is used as the unit of processing an encryption/decryption.

### SUMMARY OF THE INVENTION

The comparison between the prior art and the present invention is described below:

1. Output: The prior art outputs one bit at a time, and the present invention outputs a block at a time.

2. Playback: The prior art has to start from the beginning, and the present invention accesses randomly.

3. Cracking: The present invention adopts a two-dimensional matrix multiplication for converting plaintext and ciphertext, and thus the level of difficulty for the decryption is higher and more complicated than the one-dimensional matrix multiplication of the prior art.

4. Speed: The matrix multiplication method adopts an instruction to complete a Single Instruction Multiple Data (SIMD) operation to comply with the real time requirement.

The technical measures taken by the present invention are described as follows:

The present invention adopts a matrix architecture of diffusion algebra directly to carry out the steps of selecting a private key and a pairing private key, multiplying the private key with a plaintext to produce a ciphertext, multiplying the pairing private key with the ciphertext to obtain the plaintext, and using a single instruction operation to produce a block stream quickly.

### BRIEF DESCRIPTION OF THE DRAWINGS

FIG. 1 is a flow chart of a private key and a pairing private key in accordance with the present invention;

FIG. 2 is a flow chart of encrypting and decrypting a block stream in accordance with the present invention;

FIG. 3A is a plaintext image in accordance with the present invention;

FIG. 3B is a ciphertext image in accordance with the present invention;

FIG. 4A is a grid plaintext image in accordance with the present invention;

FIG. 4B is a grid ciphertext image in accordance with the present invention;

FIG. 5 is a flow chart of encryption and decryption using two pairs of keys in accordance with the present invention;

FIG. 6A is a ciphertext image encrypted by the two keys in accordance with the present invention;

FIG. 6B is a grid ciphertext image encrypted by the two keys in accordance with the present invention;

### DETAILED DESCRIPTION OF THE PREFERRED EMBODIMENTS

The block-based stream encryption/decryption method of the invention directly applies a matrix architecture of diffusion algebra, and the method comprises:

I. Symbols and Definitions of Diffusion Algebra

S: Bit matrix composed of n×n elements, where n>0.

I: Unit matrix of S

⊕: Bit addition is the same as the XOR operation of Boolean algebra.

For example, (a) 1⊕0=1 and (b) 1⊕1=0

\textcircled{×}: Bit multiplication is the same as the AND operation of Boolean algebra.

For example, (a) 1\textcircled{×}0=0 and (b) 1\textcircled{×}1=1

+: Matrix addition, such as (a) S=A+B [symbol] s_{i,j}=a_{i,j}⊕b_{i,j}

×: Matrix multiplication, such as (a)

$$S = A \times B ⇒ {s}_{i , j} = {⊕}_{k = 1}^{n} {a}_{i , k} ⊗ {b}_{k , j}$$

Sⁱ: S to the power of i.

For example, (a) S⁰=S, (b) S¹=S×S (c) Sⁱ×S^{j}=S^{i+j+1}

T: a cycle, S^{T}=S, T>0.

P: a prime number, SεP [symbol] S^{T-1}=I. NP: a non prime number.

For example, (a) IεP, (b) P×PεP and (c) P×NPεNP

II. Relation Between Diffusion Algebra and Linear Algebra

a. Matrix Product of Diffusion Algebra

(1) The S-bit matrix is composed of n×n elements, where n>0. In other words, the S-bit matrix is a square matrix composed of 0 and 1.

(2) The product of the diffusion is a remainder obtained by dividing the matrix product by 2 in linear algebra, and 0 remains unchanged, and an even number equal to 0, and an odd number equals to 1.

(3) S multiplied by a unit matrix I is equal to S.

b. Determination of a Prime Number

Power Operation S^{T-1}=I of Diffusion algebra.

The bit matrix keeps multiplying itself to form a n×n unit matrix.

Determinant Operation |S|=1 of Diffusion algebra

The value of a determinant of a matrix is calculated by linear algebra for determining the existence of an inverse matrix. As interpreted by diffusion algebra, the positive or negative sign of the value of a number represents the number; the even number is equal to 0, and the odd number is equal to 1. Therefore, |S|=1, where S is a prime number.

c. Formation of Private Key

A private key is formed by a private key e and a pairing private key d as follows:

e=S and d=S^{T-2} of diffusion algebra.

and S^{T}=S, T>0, where T is a cycle period.

e=S and d=S⁻¹ of Linear Algebra

If the value of the determinant of the linear algebra is an odd number, then the inverse matrix can be replaced with an adjoint matrix by diffusion algebra, and the value of its even number is changed to 0, and the value of its odd number is changed to 1.

III. Basic Principle of Encryption and Decryption

a. Process of selecting a private key:

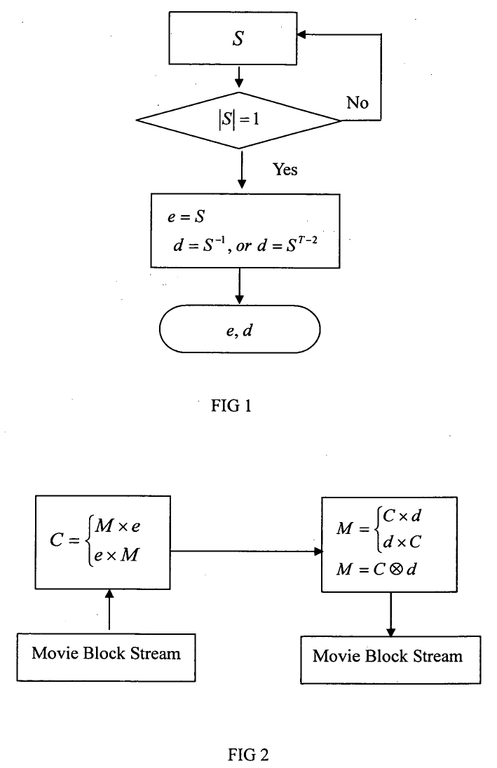

A private key e and a pairing private key d as shown in FIG. 1 are selected:

1. |S|=1;

2. S^{T-1}=I;

3. if e=S then d=S^{T-2};

b. Process of Encryption/Decryption:

The two types of operations are shown in FIG. 2:

1. C=M×e (Encryption); M=C×d (Decryption).

2. C=e×M (Encryption); M=d×C (Decryption).

A preferred embodiment of the encryption/decryption is described below:

To make our examiner easier to understand the technical characteristics of the present invention, we give the description on determining a prime number, performing a matrix multiplication and finding a private key by diffusion algebra as follows. An n×n matrix, where n=8 (which is an 8×8 matrix) as shown in Table 1 is used for illustration.

TABLE 1
$S = [ \begin{matrix}1 & 0 & 1 & 0 & 0 & 0 & 1 & 1 \\ 0 & 1 & 1 & 1 & 1 & 0 & 1 & 1 \\ 0 & 1 & 1 & 0 & 1 & 1 & 0 & 0 \\ 1 & 0 & 1 & 0 & 1 & 0 & 0 & 0 \\ 1 & 0 & 0 & 0 & 1 & 1 & 1 & 1 \\ 1 & 1 & 1 & 1 & 1 & 0 & 1 & 0 \\ 1 & 0 & 1 & 0 & 0 & 0 & 0 & 1 \\ 0 & 0 & 1 & 1 & 0 & 1 & 0 & 0\end{matrix} ]$

a. Determination of Prime Number

The value |S|=−9 of the determinant of a matrix is calculated by linear algebra. As to diffusion algebra, the positive and negative sign of the value of a number represents the number, and the even number is equal to 0, and the odd number is equal to 1. Therefore, |S|=1, where S is a prime number.

b. Operation of Matrix Multiplication

The result is the same as the matrix product obtained by linear algebra, and the even number is changed to 0, and the odd number is changed to 1, and thus the S×S matrix is shown in Table 2:

TABLE 2
$S \times S = [ \begin{matrix}0 & 1 & 0 & 1 & 1 & 0 & 1 & 0 \\ 1 & 0 & 1 & 0 & 0 & 1 & 0 & 1 \\ 0 & 1 & 1 & 0 & 0 & 0 & 1 & 0 \\ 0 & 1 & 0 & 0 & 0 & 0 & 0 & 0 \\ 0 & 1 & 0 & 0 & 0 & 0 & 1 & 1 \\ 0 & 0 & 1 & 1 & 0 & 0 & 1 & 0 \\ 1 & 1 & 1 & 1 & 1 & 0 & 1 & 1 \\ 0 & 0 & 1 & 1 & 1 & 1 & 1 & 0\end{matrix} ]$

c. Finding a Private Key:

a. Select a private key e and a pairing private key d to obtain an inverse matrix by linear algebra, and the even number is changed to 0, and the odd number is changed to 1.

b. If the inverse matrix of the private key is not an integer, then an adjoint matrix of the linear algebra can be used. The even number is changed to 0, and the odd number is changed to 1.

c. Adopt a raise-to-power operation d=S^{T-2} by diffusion algebra, and e is equal to S.

Find d=S⁻¹ by linear algebra or d=S^{T-2} by diffusion algebra, where T=8 as shown in Table 3:

TABLE 3
$d = {S}^{- 1} = {S}^{T - 2} = [ \begin{matrix}1 & 1 & 1 & 0 & 0 & 0 & 0 & 1 \\ 1 & 0 & 1 & 0 & 1 & 0 & 0 & 0 \\ 0 & 1 & 0 & 0 & 0 & 1 & 1 & 0 \\ 0 & 0 & 1 & 1 & 1 & 1 & 1 & 0 \\ 1 & 0 & 1 & 1 & 0 & 1 & 1 & 1 \\ 0 & 1 & 1 & 1 & 1 & 0 & 0 & 1 \\ 1 & 0 & 0 & 0 & 0 & 0 & 1 & 0 \\ 1 & 0 & 1 & 0 & 0 & 1 & 0 & 1\end{matrix} ]$

IV. Practical Application of Image

Select an image: Mona Lisa, 512×512 bits;

a pair of keys: e, d, T=16;

a private key: e, 16×16 bits (as shown in Table 4); and

a pairing private key: d, 16×16 bits.

TABLE 4

| e: e = S | d: d = S¹⁴ |
|---|---|
| 0001101110100111 | 0001110011001110 |
| 1000101100100001 | 0010111000000111 |
| 0111011110000111 | 0001000100000001 |
| 0110111001100101 | 1100000011111101 |
| 1100000100000001 | 0010000010100101 |
| 1011011111010110 | 0011001000000011 |
| 1100110000100011 | 1100101100000010 |
| 0000010000111000 | 0010111001010000 |
| 1000100000001000 | 0100100011100110 |
| 1110010011100110 | 1000000000011000 |
| 1110000101100000 | 1000110110100000 |
| 0010100010010101 | 1000001001001000 |
| 0011001101110010 | 0011110011101011 |
| 0101110010110010 | 1110111110000011 |
| 1001101110011100 | 1011101101010110 |
| 0100101001011101 | 0001010010011001 |

Method: C=e×M (Encryption); M=d×C (Decryption).

Process: 16×16 bits constitute a block, and a divided image constitutes 32×32 blocks. A block is selected sequentially from left to right and from up to bottom. The block is encrypted or decrypted at real time, and thus this method is called a block streaming.

V. Basic Anti-Hacker Process: A Single Block is Used for Deriving the Password.

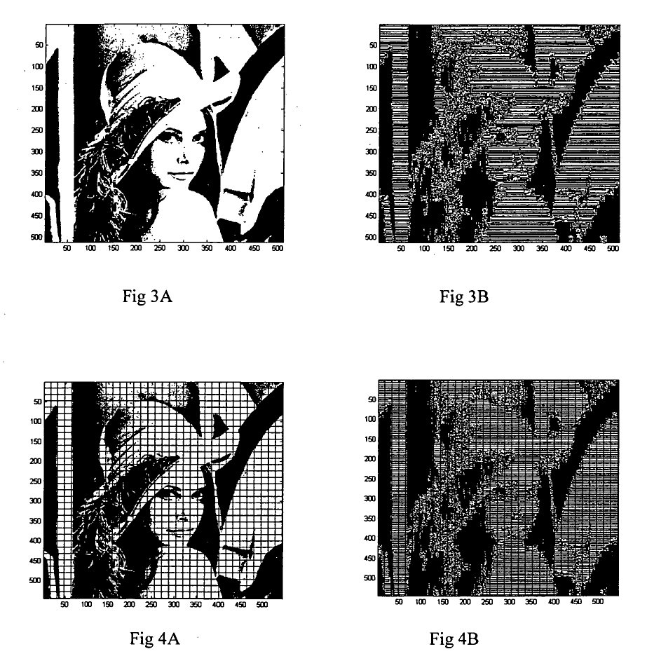

If a plaintext block is obtained in an encryption process, and the block is a prime number, then the ciphertext block can be intercepted by others easily to derive the private key e and crack the whole stream data or disable the encryption function. In general, a vast majority of movies or photos are non prime numbers. In the example of a Mona Lisa photo as shown in FIG. 3A, all blocks in the image plaintext are non prime numbers, and the encrypted image ciphertext is shown in FIG. 3B. Since the values of two adjacent columns or rows of most photos or animation screens are equal, therefore most of the blocks are non prime numbers. Once if there is a prime number, two repeated rows or columns of the block of the image ciphertext are processed as non prime numbers.

Alternatively, a row or column with a zero value is added to the block. For example, 15×15 bits constitute a block, and the divided image constitutes 34×34 blocks. If the block is encrypted, the block is mapped onto a 16×16 bit zero block to form a grid image plaintext as shown in FIG. 4A first, and then the grid image plaintext is encrypted to produce an image ciphertext as shown in FIG. 4B, and such arrangement can reduce the risk of having a hacker to crack the private key e from the ciphertext block.

VI. Advanced Anti-Hacker Process: Continuous Blocks are Used to Derive the Password.

If a plurality of plaintext blocks are obtained in an encryption process, and the number of 1 in the rows or columns of each block is too small or the sum of the blocks is a prime number, then the ciphertext blocks can be used for deriving the password. In this method, at least one pair of keys such as p, q can be added, and the cycle T=30705 as shown in FIG. 5 and Table 5:

$$Method \text{:} \begin{matrix}C = {e}_{t} \times M \\ ( {e}_{t} = e \times {p}^{t} )\end{matrix} ( Encryption ) ; \begin{matrix}M = {d}_{t} \times C \\ ( {d}_{t} = {q}^{t} \times d )\end{matrix} ( Decryption ) .$$

TABLE 5

| p: p = S | q: q = S³⁰⁷⁰³ |
|---|---|
| 1011110111110111 | 1000111000001001 |
| 1100011111001111 | 1010111011111001 |
| 1011011000100011 | 1101100101010001 |
| 0011111011001000 | 0101010010110110 |
| 1011101111110101 | 1011101000000101 |
| 0000111101011110 | 0010010000100011 |
| 1111110010000110 | 0101111010001010 |
| 1110010011110100 | 1000111110010010 |
| 1100000111001010 | 0100010111000000 |
| 1110110100101111 | 0010111111000001 |
| 1011101001000111 | 0001011110011111 |
| 1110000010000001 | 0010011101000100 |
| 0100001110000101 | 0011011101001010 |
| 0100110000110000 | 1000011001011000 |
| 0011000101100101 | 1111001010101001 |
| 0011011001011111 | 1011110001110001 |

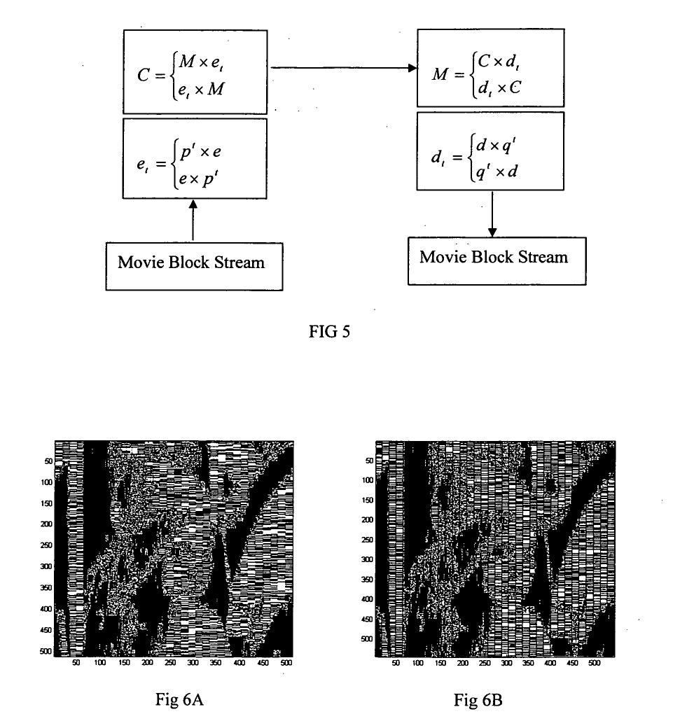

If each of the two parties on a network holds two keys, respectively a fixed key and a long-cycle key for multiplying itself Each encryption/decryption is considered as a plaintext block multiplied by a fixed key and then multiplied by a variable key. With an unknown cycle of the variable key and a fixed key for preventing the occurrence of a unit matrix produced by a cyclic operation, it is difficult to decrypt the password even by a plurality of plaintext blocks regardless of the operation for addition or multiplication. After two keys (the fixed key and the variable key) are encrypted, the result is shown in FIG. 6A. Further, a row or column with zero value can be added to the plaintext block to increase the level of difficulty of cracking. The encrypted result of the two keys is shown in FIG. 6B.

While preferred embodiments of the invention have been shown and described in detail, it will be readily understood and appreciated that numerous omissions, changes and additions may be made by persons ordinarily skilled in the art without departing from the spirit and scope of the invention.

What is claimed is:

1. A block-based stream encryption/decryption processing method, for applying a matrix architecture of diffusion algebra, at least comprising the steps of:
(a) selecting a private key and a pairing private key;
(b) selecting a plaintext, and multiplying said plaintext with said private key to produce a ciphertext;
(c) multiplying said ciphertext with said pairing private key to obtain said plaintext; and
(d) repeating the steps (b) and (c) to produce encrypted and decrypted block streams.

2. The block-based stream encryption/decryption processing method of claim 1, wherein said private key is multiplied with said pairing private key to produce a unit matrix.

3. The block-based stream encryption/decryption processing method of claim 2, wherein said private key is a prime number.

4. The block-based stream encryption/decryption processing method of claim 2, wherein said pairing private key is a prime number.

5. The block-based stream encryption/decryption processing method of claim 2, wherein said private key is multiplied with at least one prime number.

6. The block-based stream encryption/decryption processing method of claim 2, wherein said pairing private key is multiplied with at least one prime number.

7. The block-based stream encryption/decryption processing method of claim 2, wherein said private key has a long cycle period.

8. The block-based stream encryption/decryption processing method of claim 2, wherein said pairing private key has a long cycle period.

9. The block-based stream encryption/decryption processing method of claim 5, wherein said cycle period of the prime number is a relatively prime in linear algebra.

10. The block-based stream encryption/decryption processing method of claim 6, wherein said cycle period of the prime number is a relatively prime in linear algebra.

11. The block-based stream encryption/decryption processing method of claim 3, wherein said private key is a variable value, and said variable value is a product of a variable value of a previous time and at least one power of the prime number.

12. The block-based stream encryption/decryption processing method of claim 4, wherein said pairing private key is a variable value, and said variable value is a product of a variable value of a previous time and at least one power of the prime number.

13. The block-based stream encryption/decryption processing method of claim 5, wherein said private key is a constant multiplied by a variable value, and the constant is a product of at least one prime number, and said variable value is a product of a variable value of a previous time and at least one power of the remaining prime numbers.

14. The block-based stream encryption/decryption processing method of claim 6, wherein said pairing private key is a constant multiplied by a variable value, and said constant is a product of at least one prime number, and said variable value is a product of a variable value of a previous time and at least one power of the remaining prime numbers.

15. The block-based stream encryption/decryption processing method of claim 1, wherein said plaintext is a square bit matrix, and said determinant of the matrix has a zero value, and the zero value is considered as an even number for said determinant in linear algebra.

16. The block-based stream encryption/decryption processing method of claim 15, wherein said plaintext adds at least one row or column with a zero value.

17. The block-based stream encryption/decryption processing method of claim 15, wherein the plaintext is modified into at least two repeated rows or columns.

18. The block-based stream encryption/decryption processing method of claim 2, wherein the private key is a square bit matrix, and said determinant in said matrix has a value of one, and said value of one is considered as an odd number for said determinant in linear algebra.

19. The block-based stream encryption/decryption processing method of claim 18, wherein said pairing private key is an adjoint matrix of said private key in linear algebra, and the even number is changed to 0, and the odd number is changed to 1.

20. The block-based stream encryption/decryption processing method of claim 1, wherein said matrix product of diffusion algebra is equal to a remainder obtained by dividing said matrix product in linear algebra by 2.
